(19) United States
(12) Patent Application Publication
(10) Pub. No.: US 2005/0261950 A1
(43) Pub. Date: Nov. 24, 2005

(54) Method of scheduling appointment coverage for service professionals

(76) Inventor: Glenn A. McCandliss, Warren, MI (US)

Correspondence Address: Dinnin & Dunn, P.C., Suite 500, 2701 Cambridge Ct., Auburn Hills, MI, 48326, US

(21) Appl. No.: 10/851,898

(22) Filed: May 21, 2004

(51) Int. Cl. G06F 17/60

(52) U.S. Cl. 705/9

(57) ABSTRACT

A scheduling system and method are provided for communicating to a user a list of potential substitute professionals for covering previously scheduled commitments. The list communicated to the user can be subdivided based upon various factors, including proximity of the substitute professionals. The list can be further subdivided based on relative proximity.

### TECHNICAL FIELD

The present invention relates generally to processes for coordinating and scheduling events electronically, and will relate more particularly to a process of facilitating the substitution of one service professional for another with respect to a particular scheduled occurrence, based upon temporal and geographic availability of potential substitutes.

### BACKGROUND OF THE INVENTION

Advanced technology computer and communications systems have transformed many important aspects of human interactions, including to a certain extent the capacity of people to schedule and reschedule events. For example, technology has forever changed human interaction through the introduction of electronic messages and retrieval. These technologies include email, voice mail, instant messaging, and pager and cell phone technologies. Utilizing such tools, a virtually unlimited amount of information can be transmitted and received very rapidly.

With the advent of high tech systems and processes in communication, certain aspects of day to day activities have become more efficient. With the ever increasing demands placed upon busy professionals, however, and the sheer volume of information relating to commitments such as appointments, court appearances, scheduled surgical procedures, etc., a host of potentially confounding factors has arisen. While improvements in communications have enabled us to conduct more business, meet more people, and perform more tasks, the risk of intervening factors has increased. Accordingly, professionals in many different fields appear to be constantly running around, trying to meet all of their commitments, in spite of the benefits provided by technology.

Many professionals find it exceptionally difficult to find substitutes of suitable competence or experience when they are unable to keep or inconvenienced in keeping an appointment. When a busy professional needs someone to cover a scheduled appointment or appearance for them, they typically locate a substitute by placing a phone call to practitioners they know personally, often requiring numerous calls and back and forth communications before a suitable substitute can be located and confirmed.

### SUMMARY OF THE INVENTION

It is an object of the present invention to provide a simple and efficient means for busy professionals to locate a suitable substitute for scheduled engagements.

It is a further object of the present invention to provide a means for identifying a suitable substitute professional for a scheduled engagement.

In accordance with the foregoing and other objects, the present invention provides an electronic system for generating a list of professionals potentially available as a substitute for another professional. The system includes a User System having a Graphical User Interface (GUI) and a Server, preferably subdivided into at least a Profile Storage Unit and a Proximity Determination Unit.

In a related aspect, the present invention provides a process for generating a list of professionals potentially available as a substitute for another professional. The process includes a plurality of steps. First, a user creates and enters a time, date and location request. Next, the request is communicated via an electronic network to a remote server configured to store profile information from a plurality of members wishing to be available as substitutes. The remote server processes the request and generates a list of potential substitutes based on the parameters entered by the user. The generated list is subdivided based on a plurality of factors, which can include but are not limited to: geographic proximity; temporal proximity; licensing; experience; and, ethical concerns. Subdivision of the list can occur by any suitable mechanism, including visual separation, differences in color, various symbols, sounds, etc.

### BRIEF DESCRIPTION OF THE DRAWINGS

FIG. 1 is a schematic view of an electronic system in accordance with the present invention;

FIG. 2 is a flowchart illustrating a process in accordance with the present invention;

FIGS. 3-7 are schematic views of a graphical user interface display in accordance with the present invention.

### DETAILED DESCRIPTION OF PREFERRED EMBODIMENTS

The present invention broadly provides a system and process whereby a service professional or “primary user” can locate and contact suitable substitute service professionals or “secondary users” to cover a scheduled appointment, hearing, procedure or other preexisting commitment. As described herein, the term “primary user” should be understood to refer to the party activating the system to identify and contact a potential substitute, whereas the term “secondary user” refers to those users whose contact information is stored in the system for accessing by the primary user. The factors by which the suitability of the secondary users is determined include technical competence such as legal or practical specialty, certifications, procedural or jurisdictional licensing, etc., as well as time and date availability. By use of the present system and process, a service professional encountering a conflict with a prior engagement can quickly and easily produce a list of suitable, available substitutes. The system and process are both based around the primary user, who personally contacts potential substitutes once they have been identified. In addition to core availability and technical competence, the present invention provides a unique means for subdividing the list of potential substitutes based on various factors, such as geographic proximity to the primary user's scheduled appointment, at the time it is scheduled. Subdivision of the list can take various forms, including in a preferred embodiment displaying the list on the graphical user interface, with proximity of the constituents of the list displayed with different colors, as described herein.

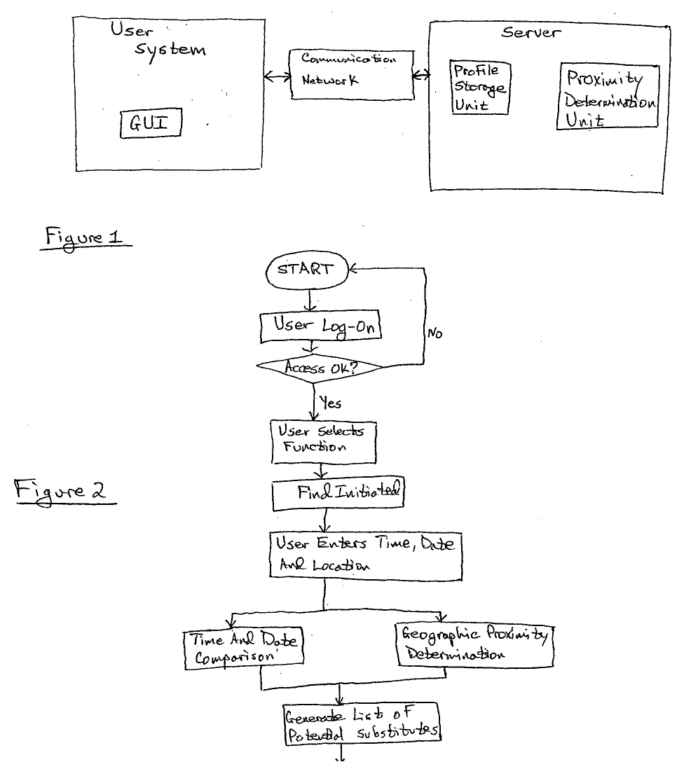

Referring to FIG. 1, there is shown a schematic diagram illustrating an electronic system in accordance with the present invention. The system includes a user system having an electronic user interface, preferably a graphical user interface (GUI) configured to electronically connect via an electronic communication network with a remote server. The electronic user interface can be generated and used at substantially any computer, for example, a handheld computer, laptop, desktop, cell phone or any other suitable system. The user system is further preferably configured to transmit over the electronic network an information packet that includes a plurality of scheduling parameters entered by the primary user, preferably including at least a date parameter and a location parameter. As used herein, the term “communication network” should be understood to include essentially any electronic network such as an internet, intranet, wired or wireless communication system. The GUI can be displayed at essentially any computer, utilizing for example an internet browser and operating system that is configured to transmit and receive information over the communication network.

The remote server preferably includes a Profile Storage Unit of various scheduling parameters for service professionals willing to be considered as substitutes for users accessing the system. As used herein, the term “server” should be understood to mean substantially any computer configured to receive, store, access and transmit information electronically over a network. The server preferably also includes means for comparing an input generated by the primary user with stored scheduling parameters of a plurality of secondary users, as described herein. Access to the user system and GUI is preferably password protected. The remote server preferably includes an input interface (not shown) configured to receive information such as schedule parameters from one or more user systems. The server further preferably includes an output interface (not shown) configured to transmit over the electronic network a list of potential substitutes based on a matching of schedule parameters entered by the primary user. In the embodiment shown in FIG. 1, the remote server further includes a Proximity Determination Unit for calculating the relative proximity of a potential substitute.

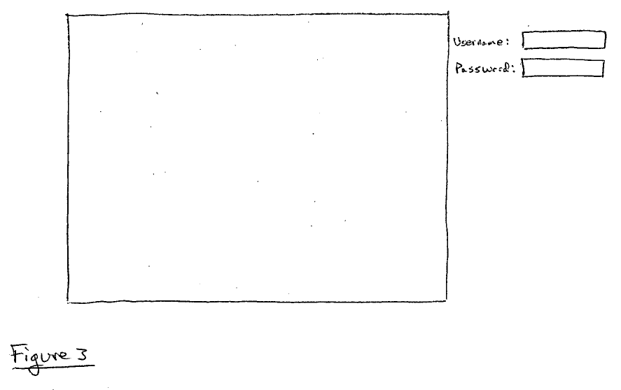

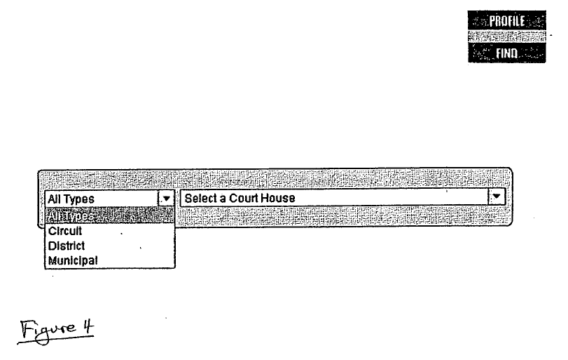

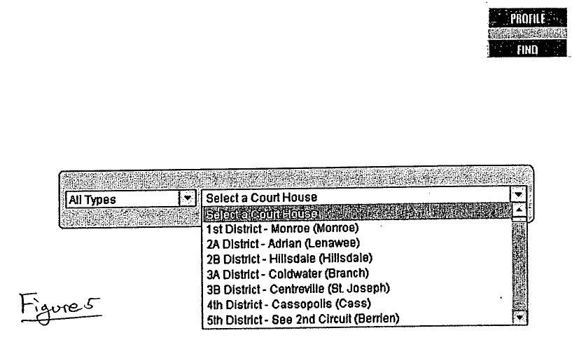

Referring to FIG. 2, there is shown a flow diagram of a process in accordance with the present invention. A preferred process is initiated when the primary user logs on or otherwise activates the user interface. The user interface preferably is an internet browser-generated graphical user interface, for example a web page displayed on a computer monitor, and accordingly, the primary user can access the system from any computer having internet access. FIG. 3 illustrates schematically a webpage-based interface with login boxes.

Once the primary user logs on to the system, the system preferably directs the primary user to a menu page where the primary user can select the desired function. In a preferred embodiment, the menu page is provided with a plurality of electronic links, for example of the type that can be activated by “clicking” with a mouse. For example, the primary user can select from a plurality of functions, including “SCHEDULE” which allows any user to enter his schedule at various dates, times and locations, such that he can be among the available professionals included on a list to other users in response to their queries. Internet based “JAM CAMS” are provided, allowing a user to view substantially real time traffic condition images on local roads.

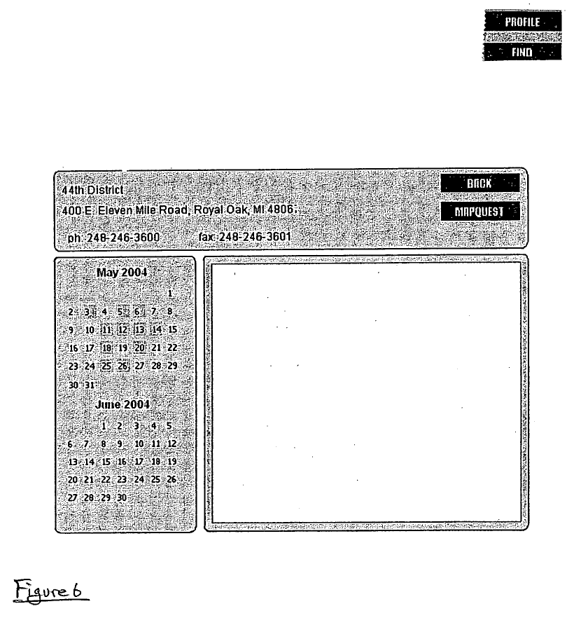

In a preferred embodiment, the menu page (not shown) allows the primary user to select a FIND function whereby he can “find” a practitioner, for example by obtaining contact information for one or more suitable secondary users, and then contact the selected secondary users. After initiating the FIND function, the primary user is preferably directed to a page from he can select a location and/or “location type,” for example, a type of court such as a Circuit, District, Municipal or Federal Court. Once the location type is selected, the primary user can select a specific location such as a specific court house, as shown in FIG. 5.

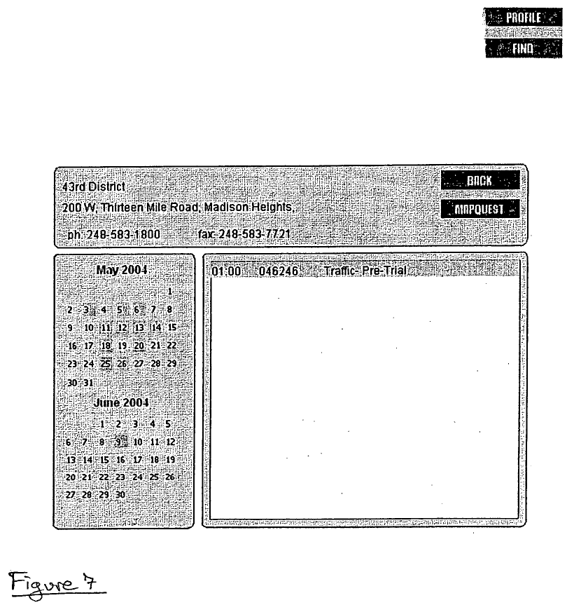

After selecting a location type and specific location, the primary user is preferably directed to a page that shows a calendar, for example a calendar including the days of one or more months, as shown in FIG. 6. The calendar page is preferably generated such that the days in which any practitioner is already scheduled at the selected location (or near the selected location, as described herein) are highlighted or otherwise visually identified. For example, shading of several of the days in the month of May 2004, shown in FIG. 6, communicates to the primary user that one or more secondary users are already scheduled at or near that location. The primary user then may click on the specific day for which he desires a substitute, after which he is directed to a page that displays a list of secondary users scheduled at or near that location on that day, and at what time. In a preferred embodiment, the secondary users are identified by an identification number such as a license number, and the type of duty for which they are scheduled. For example, FIG. 7 illustrates one potentially available substitute practitioner, scheduled to appear at one o'clock for a “Traffic Pre-Trial” matter.

Where multiple substitute practitioners are produced in the list of those potentially available, the list is preferably subdivided or segregated in one or more ways. For example, substitute practitioners might be listed in the order of their scheduled appearances at that location, for example, by time of scheduled appearance. The practitioners might also be listed or subdivided by the type of work for which they are scheduled. In one preferred embodiment, highlighting over each individual practitioner in the list varies in color depending upon whether they are actually scheduled at the location, or scheduled near the selected location. For example, yellow highlighting can be used to identify secondary users actually scheduled at the selected location whereas green highlighting might be used to locate those practitioners that are within a certain distance of that location. Still further embodiments are contemplated wherein other factors are used to subdivide the list of practitioners, or other means are used to identify the classifications or subdivisions to the primary user. After the list has been generated, the primary user can click on the practitioner in the list to view his or her contact information.

Generation of the list described above is preferably facilitated by providing a server configured to generate plural output signals generating graphical information viewable at the GUI, the graphical information corresponding to the various aspects of schedule availability relative to the substitute practitioners.

The server is preferably configured to generate a first output signal that corresponds to a first match condition between the date parameter entered by the primary user and a secondary user date parameter. The first match condition may exist, for example, where a secondary user is scheduled at the exact location selected by the primary user on the selected day. The first match condition might also be met where a secondary user is scheduled at a different location, but within a certain distance of the location scheduled by the primary user on the selected day. In a preferred embodiment the first match condition will be met, and graphically displayed as a highlighted calendar at the GUI, whenever at least one secondary user is scheduled either at, or within a predetermined distance of the location selected by the primary user. Thus, the primary user is able to readily determine if a potential substitute will be at the exact locale, or within an acceptable distance of the selected location. Other parameters may be used in calculating whether the first match condition is met. For example, embodiments are contemplated wherein the primary user can choose to filter out certain secondary users on the basis of various factors, including for example, identity, practice specialty, level of experience, etc. Still other embodiments are contemplated wherein the first match condition is met when a comparison between the primary user and secondary user schedules indicates that a secondary user is scheduled within a particular time window preceding or following a time selected by the primary user.

The server is further preferably configured to generate a second output signal that corresponds to a second match condition. When the primary user selects a particular date highlighted on the calendar (where the first match condition is met), and is directed to the page shown for example in FIG. 7, the server generates signals and communicates the same to the primary user based on whether the second or third match condition is met. The second match condition might, for example, exist where a secondary user is scheduled at the exact location selected by the primary user, whereas the third match condition may be met where a secondary user is scheduled at a nearby location. Where a list that includes a plurality of secondary users is generated, the primary user can be provided with a list showing the secondary users in different colors, each color corresponding to one of the second or third match conditions, as described above. Alternative embodiments are contemplated wherein additional match conditions are determined, and the list further subdivided. A fourth match condition might be determined, for example, where a secondary user meeting the first match condition and either of the second or third match conditions also has a selected practice specialty. Thus, the primary user can be provided with a list of a plurality of secondary users, each secondary user's name or identifier on the list being color coded to correspond to various selected factors. The degree to which the list can be subdivided is essentially unlimited.

The present description is for illustrative purposes only, and should not be construed to narrow the scope of the present invention in any way. Thus, those skilled in the art will appreciate that various modifications might be made to the presently disclosed embodiments without departing from the intended spirit and scope of the invention. Other aspects, features and advantages will be apparent upon an examination of the attached drawing Figures and appended claims.

1. A system for generating an electronic list of scheduling information and enabling access to the list by a primary user comprising:
an electronic user interface configured to transmit over an electronic network an information packet including a plurality of scheduling parameters entered by the primary user, said parameters including at least a date parameter and a location parameter;
a server operable to communicate with the user interface, said server including an electronic calendar configured to store scheduling parameters of at least one secondary user including at least a date parameter and a location parameter;
said server including an input interface configured to receive said information packet and compare the same with the stored scheduling parameters of the at least one secondary user, and an output interface configured to generate plural output signals corresponding to schedule availability of the at least one secondary user and communicate the same to the user interface over the communication network;
wherein a first output signal corresponds to a first match condition between the primary user date parameter and a secondary user date parameter, a second output signal corresponds to a second match condition between the primary user location parameter and a secondary user location parameter, and a third output signal corresponds to a third match condition between the primary user location parameter and a secondary user location parameter.

2. The system of claim 1 wherein the user interface comprises a graphical user interface having a calendar display.

3. The system of claim 2 wherein the first output signal generates at the user interface a graphical indicator of said first match condition.

4. The system of claim 3 wherein the first output signal generates at the user interface a highlighted portion of said calendar display corresponding to said first match condition.

5. The system of claim 4 wherein the second output signal generates at the user interface a first graphical display corresponding to the second match condition, and wherein the third output signal generates at the user interface a second graphical display corresponding to the third match condition.

6. A process for generating and providing to a primary user an electronic list of substitute service professionals available to cover scheduled appointments of the primary user and determining a suitable substitute from said list, the process comprising the steps of:
entering at a user interface a plurality of primary user scheduling parameters including at least a date parameter and a location parameter;
transmitting said scheduling parameters over an electronic network to a server configured to compare the primary user scheduling parameters with stored secondary user profiles consisting of a plurality of secondary user scheduling parameters, said secondary user scheduling parameters including at least a date parameter and a location parameter;
generating at the server an output signal corresponding to a match condition between the primary user date parameter and a secondary user date parameter;
transmitting the same over the electronic network, said output signal generating at the user interface a graphical representation of said match condition; and
contacting at least one of the secondary users based on meeting said match condition.

7. The process of claim 6 wherein said output signal generates at the user interface a highlighted graphical calendar.

8. The process of claim 7 wherein said output signal generates at the user interface an electronic network link; and
wherein activation of the link by the primary user prompts the server to create an electronic list of available secondary users and transmit the same to the user interface over the communication network.

9. The process of claim 8 comprising the step of prompting the server to create an electronic list subdivided by relative availability of the secondary users listed therein.

10. The process of claim 9 comprising generating at the user interface the list in a graphically subdivided fashion.

11. The process of claim 10 comprising graphically subdividing the list by generating at the user interface different colors corresponding to geographic proximity of the secondary users to a location defined by the primary user date and location parameters.

12. A method of facilitating substitution of a service professional for another service professional at a predetermined date and time comprising the steps of:
entering at an electronic user interface a plurality of scheduling parameters for a primary user including at least a date parameter and a location parameter;
transmitting said scheduling parameters over an electronic network to a remote computer configured to compare the scheduling parameters with stored secondary user profiles consisting of a plurality of secondary user scheduling parameters, said secondary user scheduling parameters including at least a date parameter and a location parameter;
generating at the remote computer an output signal corresponding to a geographic match condition between the primary user date parameter and a secondary user date parameter, and transmitting the same over the electronic network, said output signal generating at the user interface a graphical representation of said geographic match condition; and
contacting at least one secondary user who meets said geographic match condition to confirm availability at a date and location corresponding to the primary user date parameter and location parameter.

13. The method of claim 12 wherein the step of generating an output signal comprises generating a first signal type corresponding to a first type of geographic match condition, and a second signal type corresponding to a second type of geographic match condition.

14. The method of claim 13 wherein the first signal type generates at the user interface a first graphical representation corresponding to a geographic match between a secondary user location parameter and the primary user location parameter, and the second signal type generates at the user interface a second graphical representation corresponding to a near geographic match between a secondary user location parameter and a primary user location parameter.

15. The method of claim 14 wherein the geographic match consists of a secondary user scheduled at the same location as a location specified by the primary user.

16. The method of claim 15 wherein the near geographic match consists of a secondary user scheduled within a pre-selected distance of the location specified by the primary user.
